(19) United States
(12) Patent Application Publication
(10) Pub. No.: US 2003/0105186 A1
(43) Pub. Date: Jun. 5, 2003

(54) Humectant set which improves maintenance of pigment or dyepigment blend inks

(76) Inventors: Ajay Kanubhai Suthar, Lexington, KY (US); Elaine Yeap Money, Lexington, KY (US)

Correspondence Address: Kilpatrick Stockton, LLP, 1001 W. 4th Street, Winston-Salem, NC, 27101, US

(21) Appl. No.: 09/995,794

(22) Filed: Nov. 29, 2001

(51) Int. Cl. C08K 5/34; C09D 5/00; C03C 17/00

(52) U.S. Cl. 523/160; 523/161; 524/104

(57) ABSTRACT

The present invention provides a novel humectant set for use in an ink having properties suited for use in all types of printers to meet the demanding requirements, said novel humectant set comprising (a) polyethylene glycol; and (b) a diol with adjacent —OH groups; in further embodiment, comprising at least two of the following: (a) polyethylene glycol; (b) a diol with adjacent —OH group; and (c) 2-pyrrolidone; and in further embodiment, comprising (a) polyethylene glycol; (b) an alkyl diol with adjacent —OH groups; and (c) 2-pyrrolidone. Ink compositions of the present invention comprise: the humectant set of the present invention, colorant and, optionally, a penetrant and/or a binder.

### FIELD OF INVENTION

This invention relates to aqueous ink compositions, and more particularly to aqueous inks adapted to be applied to a substrate from nozzles, commonly known as ink jet inks.

### BACKGROUND OF THE INVENTION

Ink jet printing is a non-impact method of printing that involves ejecting ink from a nozzle onto paper or other print media. The actual ink ejection method may occur via several processes that employ pressurized nozzles, electrostatic fields, piezoelectric elements within the ink nozzle, or heaters for vapor phase bubble formation.

In order to be competitive, ink jet inks must meet stringent performance requirements including the need for a long shelf life, the ability not to dry and clog the nozzles when in the printhead, and yet also having the capability to dry quickly once printed onto paper or other substrates. As ink jet printing has advanced to achieve higher resolutions (i.e., more ink drops per inch) and higher print quality, the performance requirements for the jet inks have become even more critical. That is, the ink jet printer must be able to deliver a lower drop mass (i.e., smaller diameter drops) through a smaller diameter nozzle accurately and at a high frequency.

The composition of ink jet inks is traditionally deionized water, a water soluble organic solvent, and a colorant. The colorant may be a soluble dye or insoluble pigment. There are several problems associated with soluble dyes that are not applicable to insoluble pigments. These problems include poor waterfastness, poor lightfastness, poor thermal stability, facile oxidation, dye crystallization, and ink bleeding and feathering on the print medium. To circumvent these problems, pigments have become the preferred colorant. Pigments generally have better light-fast and water-fast properties and are more resistant to oxidation, in addition to having higher thermal stability.

Use of a pigment instead of a dye, however, presents solubility problems because the pigments are insoluble in aqueous media. As a result, the insoluble pigment is generally stabilized in a dispersion by a polymeric dispersant. Generally speaking, most pigment inks stabilized by polymers in aqueous media are based on an electrostatic stabilizing mechanism in which a hydrophobic group in the dispersant acts as an anchor adsorbed on the pigment particle surface through an acid-base relation, electron donor/acceptor relation, Van der Waals forces, or physical absorption. The hydrophilic group is extended into the aqueous medium to keep the dispersant soluble. This results in a competition in the dispersing process between the pigment particle and the polymer, the polymer and the solvent, and the pigment particle and the solvent. Over long periods of storage time, the dispersion of pigment may become unstable and coagulation results.

Self-dispersed pigments are also widely used in ink jet inks. They are prepared by ozone oxidation, nitric acid oxidation, and salts of hypochlorous acid. The same mechanisms as for pigment dispersions (acid-base relation, electron donor/acceptor relation, Van der Waals forces, or physical absorption) are utilized in order to make the normally insoluble pigment self-dispersible in water. This is accomplished generally by the direct addition of solubilizing groups, such as carboxylic acid groups, to the surface of the pigment. With the successful addition of these groups in high concentration on the surface, the pigment becomes water dispersible.

The key objectives of an ink jet ink are: dispersion stability, print quality, tint strength, dry time, maintainability, reliability, and image permanence to shear, water, and highlighters.

In order to keep the ink moist in print cartridge nozzles, ink jet inks are formulated with hygroscopic materials (also known as humectants and wetting agents). A higher quantity of humectants aids in keeping the nozzles clog free; however, it adversely affects ink viscosity, dry time, jetting, and smear. A proper mixture of humectants is absolutely necessary to obtain a balance of all desired functional properties.

All current pigmented inks lack the level of performance that laser printers offer. The pigment sits on the paper surface and, upon drying, can be wet and dry smeared or highlighter smeared. To circumvent this problem a binder may be used which bridges the pigment particles and helps the particles adhere better to the paper. However, this binder, due to its inherent inclination to form a film upon drying, causes partial or complete clogs of printing nozzles. To clear the nozzles, extensive maintenance and frequent cleaning are required. Finding a balance between image permanence and reduced nozzle maintenance is difficult.

Accordingly, there remains a need in the art for an ink formulation that improves maintenance requirements without sacrificing image permanence, for instance, by retaining the utility of a binder in the formulation while minimizing its clogging propensity through adequate ink hydration.

### SUMMARY OF THE INVENTION

It is an object of the present invention to provide a novel humectant set for use in an ink having properties suited for use in all types of printers to meet the demanding requirements.

The novel humectant set of the present invention comprises (a) polyethylene glycol; and (b) a diol with adjacent —OH groups.

In another embodiment, the novel humectant set of the present invention comprises at least two of the following: (a) polyethylene glycol; (b) a diol with adjacent —OH groups; and (c) 2-pyrrolidone.

In another embodiment, the novel humectant set of the present invention comprises (a) polyethylene glycol; (b) an alkyl diol with adjacent —OH groups; and (c) 2-pyrrolidone.

Ink compositions of the present invention comprise: the humectant set of the present invention, colorant and, optionally, a penetrant and/or a binder.

Further details and explanation of the invention are provided below.

### DETAILED DESCRIPTION OF THE INVENTION

The present invention comprises a novel set of humectants that may be used in pigment, or a dye-pigment blend, ink formulation for use in ink jet printing applications to provide improved image permanence and a higher resistance to shear, water, and highlighters. The pigment can be a polymeric pigment concentrate or self-dispersed pigment concentrate, or a combination of both. The humectant set of the present invention aids in the reduction of nozzle maintenance frequency through its increased resistance to coagulation and clogging.

The novel humectant set of the present invention comprises a combination of: (a) polyethylene glycol (“PEG”), such as PEG M_{w} 2000, PEG M_{w} 1000, PEG M_{w} 400 and PEG M_{w} 200, and (b) a diol with adjacent —OH groups, preferably a C₂-C₈ alkyl diol.

In a further embodiment, the novel humectant set of the present invention comprises at least two of the following: (a) polyethylene glycol (“PEG”), such as PEG M_{w} 2000, PEG M_{w} 1000, PEG M_{w} 200, and preferably PEG M_{w} 400, (b) a diol with adjacent —OH groups, preferably a C₂-C₈ alkyl diol, such as 1,2-propanediol, 1,2-butanediol, 2,3-butanediol, 1,2 hexanediol, 1,2-pentanediol, 1,2-octanediol, and 2,3-pentanediol; and (c) 2-pyrrolidone.

In a further embodiment, the novel humectant set of the present invention comprises (a) polyethylene glycol (“PEG”); (b) an alkyl diol with adjacent —OH groups; and (c) 2-pyrrolidone.

In a further embodiment, the humectant set of the present invention comprises a combination of (a) polyethylene glycol, (b) 1,2-propanediol, and (c) 2-pyrrolidone, preferably, from about 1% to about 14%1 polyethylene glycol (PEG400), from about 1% to about 14% 1,2-propanediol, and from about 1% to about 14% 2-pyrrolidone, more preferably, from about 3% to about 8% polyethylene glycol (PEG400), from about 3% to about 8% 1,2-propanediol, and from about 3% to about 8% 2-pyrrolidone.

Ink compositions of the present invention comprise: the humectant set of the present invention, colorant and, optionally, a penetrant and/or a binder.

The ink compositions comprising the novel humectant set of the present invention provide reduced ink drying time as well as reduced printer maintenance requirements over humectants known in the art. While not wishing to be bound by any particular theory, it is believed that the structure of the alkyl diol having adjacent —OH groups lowers the ink surface tension, which results in faster drying time when it is printed on media (paper). Furthermore, the alkyl diol having adjacent —OH groups retains enough moisture in the ink formulation mixture to prevent pigment binder desiccation. With adequate hydration, the pigment binder cannot form films associated with printer nozzle clogging. As a result, the novel humectant set of the present All stated ranges include all ranges subsumed therein. invention produces a pigmented ink that exhibits better idling maintenance and reliability along with enhanced image permanence.

Colorant and Dispersant

Colorants useful in the present invention include pigments, self-dispersed pigment blends, polymeric pigment dispersions, pigment-dye blends, and combinations thereof. The pigment can be a polymeric pigment concentrate or self-dispersed pigment concentrate, or a combination of both.

As is known in the art, a pigment dispersion is a mixture of a pigment and a dispersing agent, typically a polymeric dispersant compound. A wide variety of organic and inorganic pigments, alone or in combination, may be selected for use in the aqueous inks of the present invention. The key selection criterion for the pigment is that they must be dispersible in the aqueous medium. The term “pigment,” as used herein, means an insoluble colorant. The selected pigment may be used in dry or wet form.

Suitable pigments include organic and inorganic pigments, and essentially any of the classes of pigments heretofore used in this art, of a particle size sufficient to permit free flow of the ink through the ink jet printing device, especially at the ejecting nozzles that usually have a diameter ranging from about 10 microns to about 50 microns. Thus, a suitable pigment particle size is from about 0.02 to about 15, preferably from about 0.02 to about 5, and more preferably from about 0.02 to about 1, micron(s). Pigments suitable for use in the present invention include azo pigments, such as azo lakes, insoluble azo pigments, condensed azo pigments and chelate azo pigments, polycyclic pigments, perylene pigments, anthraquinone pigments, quinacridone pigments, dioxazine pigments, thioindigo pigments, isoindolinone pigments, quinophthalone pigments, and dry lakes. Suitable organic pigments include nitro pigments, aniline black and daylight fluorescent pigments. Preferred pigments include carbon black, Pigment Red 122, Pigment Red 202, Pigment Yellow 74, Pigment Yellow 128, Pigment Yellow 138, Pigment Yellow 155, Pigment Blue 15:3 and Pigment Blue 15:4.

Appropriate dispersants include those known in the art, such as the acrylic terpolymers taught in commonly-assigned U.S. Pat. No. 5,719,204, and other commonly known dispersants. Factors to be considered in selecting an appropriate dispersant include the following: First, the dispersant must firmly anchor to the pigment particle surface to withstand shear force and the competition of other chemical species. To ensure this anchoring, a careful match of the polarity of the pigment particle surface and the hydrophobic group in the dispersant is required. Second, the physical dimensions of the hydrophobic group in the dispersant must be adequate to fully cover the pigment surface, otherwise, the adsorbed polymer will act as a flocculent. Third, an electrostatic layer of a requisite thickness around the particle is needed to prevent aggregation of particles within the aqueous medium.

The pigment to dispersant (weight) ratio is preferably from about 3:1 to about 5:1, but may vary from about 1:1 to about 9:1.

Dyes that are commonly used in ink jet inks such as, for example, Acid, Direct, Food, and Reactive dyes, are all suitable for use as colorants in the present invention. Essentially any dye that permits the formation of colored visible images on a recording medium may be used, including anthraquinones, mono- and di-azo dyes, phthalocyanines, and formazan copper complexes. Dye-pigment blends are preferred as they provide better waterfastness and lightfastness.

The amount of colorant in the ink composition may be varied depending on a number of factors, including structure, but the colorant is commonly present in an amount of from about 0.5% to about 10%, preferably of from about 2% to about 6%, by weight of the ink composition (based on total weight of the ink). In a preferred embodiment of the present invention, the pigment utilized in the ink formulation comprises pigment in a concentration of from about 3% to about 4% by weight.

In a preferred embodiment of the present invention, the dispersant may be comprised of two distinct segments: a hydrophilic segment and a hydrophobic segment. The hydrophilic segment is responsible for controlling polymer solubility in the aqueous medium of the dye. Therefore, this portion of the dispersing polymer is comprised of monomers containing several hydrophilic groups to ensure adequate solubility. Common hydrophilic functional groups include carboxylic acids, sulfonic acids, phosphate and carbonyl groups. As a result of their high carboxy content, acrylic and methacrylic acid monomers are often used to produce the hydrophilic segment of the polymeric dispersant. The hydrophobic segment is responsible for anchoring the polymeric dispersant to the pigment particle. A preferred dispersant comprises from about 0.2% to about 0.8% of an acrylic terpolymer such as that taught in commonly-assigned U.S. Pat. No. 5,719,204.

Binder

A binder may also optionally be used in the ink composition of the present invention to bridge the pigment particles within the ink and aid in their adhesion to the print medium. The use of a binder allows for greater ink durability and increased image permanence. Suitable binders include acrylic binders, commonly methacrylates and acrylates, with particle size ranges from 200-500 μm, preferably 250-350 nm. High T_{G} binders are generally preferred for long term jetting requirements, but low T_{G} binders are preferable for smear permanence. Also preferred are unimodal random (not block) polymer binders.

A preferred binder in the present invention may comprise from about 0% to about 5% ACRYJET 3666® by weight in the ink composition. ACRYJET 3666® is a proprietary unimodal acrylic emulsion obtained from Rohm & Haas, which contains a random copolymer comprised of butylmethacrylate and methylmethacrylate monomers. Further details on ACRYJET 3666® are as follows:

| | |
|---|---|
| % Solids | 24.5-25.5 |
| pH within 24 hours of manufacture | 8.5-9.0 |
| pH with 24 hours of shipment | 7.5-9.0 |
| Particle Size, average diameter (nm) | 275-325 |
| Particle Size Distribution | >80 |
| T_{G}(° C.) | −12-−4 |
| GPC Molecular Weight | 150,000-300,000 |
| Headspace GC for Residual | |
| Monomer | |
| ppm BA (Butylacrylate) | <350 |
| ppm MMA (Methyl Methacrylate) | <10 |

ACRYJET 3666® provides superior smear permanence and long term jetting without clogging print nozzles, as compared to current binders. The hydrophilic nature of the carboxy functionality associated with the monomers allows ACRYJET 3666® to circumvent potential solubility problems when placed into an aqueous environment. ACRYJET 3666® exhibits a glass transition temperature between about −12° C. and about −4° C. and an average particle size is in the range of from about 275 nm to about 325 nm. Thus, because of its low TG, ACRYJET 3666® forms a film at room temperature and prevents smearing of pigment on the media surface, eliminating the need for inclusion of a fuser in the ink jet printer.

Penetrant

A penetrant may also optionally be used in the ink composition of the present invention to improve penetration by the ink drops into the surface of the printed substrate and to reduce or eliminate intercolor bleeding (i.e., lateral bleeding of color). Penetrants (which include surfactants) are preferred for use in the invention. Preferred penetrants for use in the present invention include 1,2 alkyl diols containing from about 4 to about 10 carbon atoms in the alkyl group such as those taught in commonly-assigned U.S. Pat. No. 5,364,461. Most preferred are 1,2-hexanediol and hexyl carbitol. In a preferred embodiment, the penetrant is present in the ink composition in an amount of from between about 0.1% to about 6% by weight, preferably 0.3% to about 3%.

Co-Solvent

To aid in maintaining the colorant in solution and enhance ink performance, a co-solvent may be present in the ink composition. Inclusion of an aqueous carrier medium, which is generally present at from about 80% to about 99% of the composition, is preferred. The aqueous carrier medium comprises water (preferably deionized water) and, preferably, at least one water soluble organic solvent.

Selection of a suitable carrier mixture depends on the requirements of the specific application involved, such as desired surface tension and viscosity, the selected pigment, the desired drying time of the ink, and the type of paper onto which the ink will be printed. Representative examples of water soluble organic solvents that may be selected include: (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols, such as acetone, methyl ethyl ketone and diacetone alcohol; (3) ethers, such as tetrahydrofuran and dioxane; (4) esters, such as ethyl acetate, ethyl lactate, ethylene carbonate and propylene carbonate; (5) polyhydric alcohols, such as ethylene glycol, diethylene glycol, triethylene glycol, propylene glycol, tetraethylene glycol, polyethylene glycol, glycerol, 2-methyl-2,4-pentanediol, 1,2,6-hexanetriol and thiodiglycol; (6) lower alkyl mono- or di-ethers derived from alkylene glycols, such as ethylene glycol monomethyl (or monoethyl) ether, diethylene glycol monomethyl (or monoethyl) ether, propylene glycol monomethyl (or monoethyl) ether, triethylene glycol monomethyl (or monoethyl) ether and diethylene glycol dimethyl (or diethyl) ether; (7) nitrogen-containing cyclic compounds, such as pyrrolidone, N-methyl-2-pyrrolidone, and 1,3-dimethyl-2-imidazolidinone; and (8) sulfur-containing compounds, such as dimethyl sulfoxide and tetramethylene sulfone. Other useful organic solvents include lactones and lactams. Examples of suitable substituted or unsubstituted lactams include 2-pyrrolidone, 1-methyl 2-pyrrolidone, and N-(2-hydroxyethyl)-2-pyrrolidone. Co-solvents may also include 1°, 2°, and 3° amides, either alone or in a mixture with any of the above-mentioned co-solvents. Mixtures of these solvents may be used in the present invention.

Co-solvents are typically present in an amount of from about 5% to about 30% by weight, and more preferably from about 10% to about 30% by weight, including all ranges subsumed therein. As will be appreciated, the amounts of co-solvent will be dependent in part on the other components of the ink.

Preferred co-solvents for use in the present invention include a compatible mixture of a lactam, such as 2-pyrrolidone (from about 1% to about 15%, and preferably from about 3% to about 10% by weight) and polyethylene glycol (from about 1% to about 15% by weight).

Other Components

The ink composition of the present invention may also include other desirable components which have heretofore been included in jet printing ink compositions including surfactants, chelating agents, biocides, viscosity modifiers, and pH buffers.

Surfactants, such as for example, SILWET®, may be added to modify the surface tension of the ink and to control the penetration of the ink into the paper. Such surfactants are included in the ink compositions, and are not a component of the dispersant. Suitable surfactants include nonionic, amphoteric and ionic surfactants, preferred surfactants include alkyl sulfate, nonyl phenyl polyethylene glycol, SILWET® (OSI Sealants, Inc.), TERGITOL® (Union Carbide) and SURFYNOL® (Air Products and Chemicals, Inc.).

Chelating agents, such as for example, ethylene diamine tetraacetate (EDTA), may be added to prevent any deleterious effects from metal or alkali metal ion contaminants or impurities. Typically, a chelating agent may be added to the composition in an amount of from about 0.1% to about 1.0% by weight.

Biocides, such as for example, 1,2-benz-isothiazolin-3-one, may be added to the ink to prevent or inhibit growth of microorganisms in the ink. A preferred biocide is Proxel® GXL, available from Avecia, Inc., Wilmington, Del. Generally, the addition of from about 0.1% to about 1.9% by weight of a biocide will be efficacious, preferably from about 0.1% to about 0.2%

Buffering agents, preferably potassium hydroxide, may also be added to adjust or maintain a desired pH for the ink. As will be appreciated, the amount of buffer will depend on the other components in the ink. However, it has been found that the addition of small amounts of buffer to the ink, such as from about 0.01% to about 0.3% by weight, is useful.

Although not necessary, other desired components, such as viscosity modifiers, anti-kogation agents, anti-curling agents, and anti-bleed agents, may optionally be added to the ink composition at their art established levels.

Ink Preparation

The inks of the present invention may be prepared by essentially any process for preparing ink jet inks. A preferred procedure for preparing an illustrative ink is as follows: Humectants, penetrant(s) and binder are added to the DI water and mixed for 20 minutes. Pigment concentrates (for dispersion) are then slowly added and mixed for an additional 20 minutes. The pH of the ink is adjusted to from about 8.2 to about 8.5 with the pH buffer while mixing. The ink is then filtered through a series of filters, with the final filter being 1.2 microns. The median particle size determined by Microtrac UPA 150 measurements is from about 20 nm to about 150 nm.

### EXAMPLES

In order that the invention may be more readily understood, reference is made to the following examples, which are intended to be illustrative of the invention, but are not intended to be limiting in scope.

Ink formulations in accordance with the present invention were prepared as described below.

### Example One

### Preparation A

Polymeric pigments were made using a process similar to the process discussed in commonly-assigned U.S. Pat. No. 5,719,204. Carbon black, dispersant and Proxel GXL® were premixed in deionized (DI) water by mechanical stirring. The mixture was then dispersed by an attrition process using a Szegvari attritor with 10-12 mesh zirconium silicate shot at a speed of about 700 rpm for a minimum of one hour.² DI water was added for dispersion once the mixture was removed from the attritor to achieve a final dispersion solids percentage of from about 12% to about 18%. ² Longer times at controlled temperature can also be used.

### Example Two

### Preparation B

Carbon black was reacted with an oxidizing agent for a few hours. The chemical reaction that occurred directly placed hydrophilic carboxylic acid groups on the surface of the carbon black and created a water miscible dispersion. This self-dispersed concentrate was then treated in an ultrafiltration unit in order to remove excess salts, iron and other ionic contaminants.

### Example Three

### Testing

A series of mono pigment inks were made by varying the humectant set in the ink. The inks were prepared in a manner similar to the preparations described above and contained the components as listed in Table 1 and Table 2A.

TABLE 1

| INGREDIENT | FUNCTION | QUANTITY (WT %) |
|---|---|---|
| Polymeric pigment concentrate | Colorant | 25% |
| Humectant Set | Humectant | 15%, |
| | | see Table 2 |
| 1,2 Hexanediol | Penetrant | 0.5 |
| Hexyl Carbitol | Penetrant | 0.5 |
| Acryjet 3666 ®³ | Binder | 2.5 |
| Proxel GXL ®⁴ | Biocide | 0.2 |
| Deionized water | | Balance |

³ACRYJET 3666 ® is a proprietary unimodal acrylic emulsion obtained from Rohm & Haas, which contains 1.3% acid and is KOH neutralized. The specification sheet provided to Lexmark by Rohm & Haas sets forth a specification for residual methyl methacrylate and butyl acrylate monomer, the two primary components of ACRYJET 3666 ®.
⁴PROXEL GXL ® is the trade name of the solution of 1,2-benzisothiazolin-3-one (BIT), Sodium hydroxide, and dipropylene glycol, available from Avecia, Inc., Wilmington, DE.

TABLE 2A

| Humectant | Ink | Ink | Ink | Ink | Ink | Ink | Ink | Ink | Ink | Ink |
|---|---|---|---|---|---|---|---|---|---|---|
| (WT %) | 1 | 2 | 3 | 4 | 5 | 6 | 7 | 8 | 9 | 10 |
| PEG400 | | 7.5 | 7.5 | | | | | | | |
| PEG1000 | 5 | | | | 5 | 5 | 5 | 5 | 5 | 5 |
| 2-Pyrrolidone | 5 | 7.5 | | 7.5 | 5 | 5 | 5 | 5 | 5 | 5 |
| 2,2-Thiodiethanol | 5 | | 7.5 | 7.5 | | | | | | |
| PPG425 | | | | | 5 | | | | | |
| 1,2-Propanediol | | | | | | 5 | | | | |
| 1,3-Propanediol | | | | | | | 5 | | | |
| 1,5-Propanediol | | | | | | | | 5 | | |
| 3-Methyl-2- | | | | | | | | | 5 | |
| Oxazolidinone | | | | | | | | | | |
| 1,4-CHDM | | | | | | | | | | 5 |

The results of the testing of Inks 1 to 10 are summarized below. The inks were tested on a Lexmark 7000 printer.

TABLE 2B

| | Ink | Ink | Ink | Ink | Ink | Ink | Ink | Ink | Ink | Ink |
|---|---|---|---|---|---|---|---|---|---|---|
| TEST | 1 | 2 | 3 | 4 | 5 | 6 | 7 | 8 | 9 | 10 |
| 24 hr. Uncapped | Good | Good | Good | Good | Poor | Good | Good | Good | Good | Good |
| Start-up⁵ | | | | | | | | | | |
| Dry Smudge⁶ | Good if smearing at 30 minutes after printing | | | | | | | | | |
| (avg. of 2 plain | | | | | | | | | | |
| papers) | | | | | | | | | | |
| Highlighter | Excellent if smearing at 10 minutes after printing | | | | | | | | | |
| Resistance⁷ (avg. | | | | | | | | | | |
| of 2 plain papers) | | | | | | | | | | |
| Idling | <6 | ≦6 | <6 | <6 | 12 | 9 | <6 | <6 | 6 | ≦6 |
| Maintenance⁸ | | | | | | | | | | |

| | | | |
|---|---|---|---|
| Reliability⁹ | Good | Poor | Good |

⁵Uncapped Start-up is a measure of the capability of the ink to jet after exposing the nozzles to ambient air for 24 hours. Good indicates that less than 2% of nozzles dropped out.
⁶Dry smudging is measured subjectively from bad to excellent. Excellent indicates no smearing of image upon rubbing. Good indicates hardly noticeable for smearing upon rubbing. Poor indicates some smearing. Bad indicates substantial smudging.
⁷Highlighter resistance is measured subjectively from bad to excellent. Excellent indicates no smearing upon highlighter rubbing. Good indicates hardly noticeable for smearing. Poor indicates some smearing. Bad indicates substantial smudging.
⁸Idling maintenance is a subjective evaluation of the capability of the ink to jet immediately after several seconds of idling. Idling causes drying of the ink in the print cartridge nozzles which affects the accuracy of drop placement. A longer idle time represents a better maintenance quality of the ink.
⁹Reliability is a long term life test. Good indicates less than 2% of nozzles dropped out after printing 1000 g of ink.

As seen in the test results, Ink 6, which contains 1,2 Propanediol, PEG M_{w} 1000 and 2-Pyrrolidone gave the best idle time without sacrificing uncapped start-up or reliability, yet gave similar smear resistance compared to other humectants.

### Example Four

### Testing

A pigment ink formulation of the present invention (hereafter referred to as “New Ink”) was tested against a control pigment ink formulation in order to quantify any improved physical properties. In addition, Ink B of the present invention, which contained the new humectant set according to the present invention without binder, was tested and compared to Ink A, which contained a traditional humectant set. The ink formulations were prepared in the manner described above and contained the components as listed in Table 3.

TABLE 3

| | | QUANTITY (WT %) | | | |
|---|---|---|---|---|---|
| INGREDIENT | FUNCTION | Control | New Ink | Ink A | Ink B |
| Pigment | Colorant | 24.0 | 26.0 | 26.0 | 26.0 |
| concentrate | | | | | |
| Polyethylene | Humectant | | 5.0 | | 5.0 |
| Glycol (mw400) | | | | | |
| Polyethylene | Humectant | 5.0 | | 5.0 | |
| Glycol | | | | | |
| (mw1000) | | | | | |
| 1,2 Propanediol | Humectant | | 5.0 | | 5.0 |
| 2-Pyrrolidone | Humectant | 5.0 | 5.0 | 5.0 | 5.0 |
| 2,2-Thiodiethanol | Humectant | 5.0 | | 5.0 | |
| 1,2 Hexanediol | Penetrant | 0.5 | 2.6 | 2.6 | 2.6 |
| Acryjet 3666 ®¹⁰ | Binder | | 1.0 | 0 | 0 |
| Proxel GXL ®¹¹ | Biocide | 0.2 | 0.2 | 0.2 | 0.2 |
| Deionized water | | Balance | Balance | Balance | Balance |

¹⁰ACRYJET 3666 ® is a proprietary unimodal acrylic emulsion obtained from Rohm & Haas, which contains 1.3% acid and is KOH neutralized. The specification sheet provided to Lexmark by Rohm & Haas sets forth a specification for residual methyl methacrylate and butyl acrylate monomer, the two primary components of ACRYJET 3666 ®.
¹¹PROXEL GXL ® is the trade name of the solution of 1,2-benzisothiazolin-3-one (BIT), Sodium hydroxide, and dipropylene glycol, available from Avecia, Inc., Wilmington, DE.

The results of the testing of New Ink, Ink A (traditional) and Ink B of the present invention are summarized in Tables 4 and 5 below. The inks were tested on a Lexmark J110 printer.

TABLE 4

| TEST | CONTROL | NEW INK |
|---|---|---|
| Optical Density¹² (avg. of 13 papers) | 1.53 | 1.54 |
| Dry Time¹³ (SEC) (avg. of 13 plain | 7.3 | 3.8 |
| papers) | | |
| 24 hr. Uncapped Start-up¹⁴ | Good | Good |
| Dry Smudge¹⁵ (avg. of 6 plain | | |
| papers) | | |
| 5 minutes after printing | Poor | Good |
| 10 minutes after printing | Poor | Good |
| Highlighter Smear Resistance¹⁶ (avg. of 6 | Poor after | Excellent after |
| plain papers) | 24 hours | 24 hours |
| Waterfastness¹⁷ | Excellent | Excellent |
| Idling Maintenance¹⁸ | 14 seconds | 14 seconds |
| Reliability¹⁹ | Good | Good |
| Ink/Concentrate Stability²⁰ | Good | Good |

¹²Optical density indicates the darkness of the image. The higher the optical density, the richer the color.
¹³Dry time is the number of seconds it takes for the image to be dry-to-touch.
¹⁴Uncapped Start-up is a measure of the capability of the ink to jet after exposing the nozzles to ambient air for 24 hours. Good indicates that less than 2% of nozzles dropped out.
¹⁵Dry smudging is measured subjectively from bad to excellent. Excellent indicates no smearing of image upon rubbing. Good indicates hardly noticeable for smearing upon rubbing. Poor indicates some smearing. Bad indicates substantial smudging.
¹⁶Highlighter resistance is measured subjectively from bad to excellent. Excellent indicates no smearing upon highlighter rubbing. Good indicates hardly noticeable for smearing. Poor indicates some smearing. Bad indicates substantial smudging.
¹⁷Waterfastness is measured subjectively from bad to excellent. Excellent indicates no smearing of image upon squirting of deionized water on the printed images.
¹⁸Idling maintenance is a subjective evaluation of print quality measured relative to the capability of the ink to jet immediately after several seconds of idling. Idling causes drying of the ink in the print cartridge nozzles which affects the accuracy of drop placement. A longer idle time represents a better maintenance quality of the ink.
¹⁹Reliability is a long term life test. Good indicates less than 2% of nozzles dropped out after printing 1000 g of ink.
²⁰Ink/concentrate stability is measured in oven at 60° C. for three months. Good indicates no growth in particle size of the ink or concentrate.

TABLE 5

| TEST | Ink A (no binder) | Ink B (no binder) |
|---|---|---|
| 24 hr. Uncapped Start-up²¹ | Good | Good |
| Dry Smudge²² (avg. of 6 plain | | |
| papers) | | |
| 5 minutes after printing | Poor | Poor |
| 10 minutes after printing | Poor | Poor |
| Highlighter Smear Resistance²³ | Poor after | Poor after |
| (avg. of 6 plain papers) | 24 hours | 24 hours |
| Idling Maintenance²⁴ | 18 seconds | 22 seconds |
| Reliability²⁵ | Good | Good |
| Ink/Concentrate Stability²⁶ | Good | Good |

²¹Uncapped Start-up is a measure of the capability of the ink to jet after exposing the nozzles to ambient air for 24 hours. Good indicates that less than 2% of nozzles dropped out.
²²Dry smudging is measured subjectively from bad to excellent. Excellent indicates no smearing of image upon rubbing. Good indicates hardly noticeable for smearing upon rubbing. Poor indicates some smearing. Bad indicates substantial smudging.
²³Highlighter resistance is measured subjectively from bad to excellent. Excellent indicates no smearing upon highlighter rubbing. Good indicates hardly noticeable for smearing. Poor indicates some smearing. Bad indicates substantial smudging.
²⁴Idling maintenance is a subjective evaluation of print quality measured relative to the capability of the ink to jet immediately after several seconds of idling. Idling causes drying of the ink in the print cartridge nozzles which affects the accuracy of drop placement. A longer idle time represents a better maintenance quality of the ink.
²⁵Reliability is a long term life test. Good indicates less than 2% of nozzles dropped out after printing 1000 g of ink.
²⁶Ink/concentrate stability is measured in oven at 60° C. for three months. Good indicates no growth in particle size of the ink or concentrate.

Thus, as seen above, the performance of the New Ink formulation of the present invention is equal to, or surpasses, that of the control ink in every physical category. If a binder is added to improve smear performance, it usually worsens reliability, nozzle start-up and print head maintenance. However, the new humectant set overcame these issues and still met the goals of much improved archival on papers. In addition, Ink B of the present invention improved idling maintenance without binder in the ink formulation, thus illustrating the unique quality of the humectant set of the present invention of providing improved maintenance performance with or without the presence of binder in the ink. In sum, the ink formulation of the present invention serves to increase the quality of ink jet printing and make it a more attractive alternative to expensive laser printing methods.

The use of acrylic binders other than Acryjet 3666® was also tested in an ink composition otherwise similar to the New Ink formulation of the present invention. The results showed equally good maintenance with the humectant set as presented in this invention.

In addition, testing of dye-pigment blended inks comprising humectant set of the present invention demonstrated improved maintenance.

In sum, test results demonstrate that there is improvement on maintenance such as idle time, start-up and reliability for pigment inks comprising the novel humectant set of the present invention.

While certain representative embodiments and details have been shown for purposes of illustrating the invention, it will be apparent to those skilled in the art that various changes in the methods and apparatus disclosed herein may be made without departing from the scope of the invention, which is defined in the appended claims.

We claim:

1. An ink composition comprising:
(a) polyethylene glycol; and
(b) an alkyl diol with adjacent —OH groups.

2. The ink composition of claim 1 further comprising a penetrant.

3. The ink composition of claim 2 wherein said penetrant is 1,2-hexanediol.

4. The ink composition of claim 2 wherein said penetrant is hexyl carbitol.

5. The ink composition of claim 2 wherein said penetrant comprises from about 0.1% to about 6% by weight of said ink composition.

6. The ink composition of claim 1 further comprising a colorant.

7. The ink composition of claim 6 wherein said colorant is a pigment.

8. The ink composition of claim 7 wherein said pigment comprises one of the following: (a) a polymeric pigment concentrate; (b) a self-dispersed pigment concentrate; and (c) a combination of (a) and (b).

9. The ink composition of claim 1 further comprising a binder.

10. The ink composition of claim 9 wherein said binder comprises an acrylic binder.

11. The ink composition of claim 10 wherein said acrylic binder further comprises a unimodal random polymer.

12. An ink composition comprising at least two of the following:
(a) polyethylene glycol;
(b) an alkyl diol with adjacent —OH groups; and
(c) 2-pyrrolidone.

13. The ink composition of claim 12 wherein said diol comprises a C₂-C₈ alkyl diol.

14. The ink composition of claim 12 wherein said diol comprises 1,2-propanediol.

15. The ink composition of claim 14 wherein said 1,2-propanediol comprises from about 1% to about 14% by weight of said ink composition.

16. The ink composition of claim 14 wherein said 1,2-propanediol comprises from about 3% to about 8% by weight of said ink composition.

17. The ink composition of claim 12 wherein said diol comprises from about 1% to about 14% by weight of said ink composition.

18. The ink composition of claim 12 wherein said polyethylene glycol is PEG M_{w} 400.

19. The ink composition of claim 12 wherein said polyethylene glycol comprises from about 1% to about 14% by weight of said ink composition.

20. The ink composition of claim 12 wherein said 2-pyrrolidone comprises from about 3% to about 8% by weight of said ink composition.

21. The ink composition of claim 12 further comprising a penetrant.

22. The ink composition of claim 21 wherein said penetrant is 1,2-hexanediol.

23. The ink composition of claim 21 wherein said penetrant is hexyl carbitol.

24. The ink composition of claim 21 wherein said penetrant comprises from about 0.1% to about 6% by weight of said ink composition.

25. The ink composition of claim 12 further comprising a colorant.

26. The ink composition of claim 25 wherein said colorant is a pigment.

27. The ink composition of claim 26 wherein said pigment comprises one of the following: (a) a polymeric pigment concentrate; (b) a self-dispersed pigment concentrate; and (c) a combination of (a) and (b).

28. The ink composition of claim 12 further comprising a binder.

29. The ink composition of claim 28 wherein said binder comprises an acrylic binder.

30. The ink composition of claim 29 wherein said acrylic binder further comprises a unimodal random polymer.

31. An ink composition comprising:
(a) polyethylene glycol;
(b) an alkyl diol with adjacent —OH groups; and
(c) 2-pyrrolidone.

32. The ink composition of claim 31 wherein said diol comprises a C₂-C₈ alkyl diol.

33. The ink composition of claim 31 wherein said diol comprises 1,2-propanediol.

34. The ink composition of claim 31 wherein said diol comprises from about 1% to about 14% by weight of said ink composition.

35. The ink composition of claim 33 wherein said 1,2-propanediol comprises from about 1% to about 14% by weight of said ink composition.

36. The ink composition of claim 33 wherein said 1,2-propanediol comprises from about 3% to about 8% by weight of said ink composition.

37. The ink composition of claim 31 wherein said polyethylene glycol is PEG M_{w} 400.

38. The ink composition of claim 31 wherein said polyethylene glycol comprises from about 1% to about 14% by weight of said ink composition.

39. The ink composition of claim 31 wherein said 2-pyrrolidone comprises from about 3% to about 8% by weight of said ink composition.

40. The ink composition of claim 31 further comprising a penetrant.

41. The ink composition of claim 40 wherein said penetrant comprises a 1,2 alkyl diol containing from about 4 to about 10 carbon atoms in the alkyl group.

42. The ink composition of claim 40 wherein said penetrant is 1,2-hexanediol.

43. The ink composition of claim 40 wherein said penetrant is hexyl carbitol.

44. The ink composition of claim 40 wherein said penetrant comprises from about 0.1% to about 6% by weight of said ink composition.

45. The ink composition of claim 31 further comprising a colorant.

46. The ink composition of claim 45 wherein said colorant is a pigment.

47. The ink composition of claim 46 wherein said pigment comprises one of the following: (a) a polymeric pigment concentrate; (b) a self-dispersed pigment concentrate; and (c) a combination of (a) and (b).

48. The ink composition of claim 31 further comprising a binder.

49. The ink composition of claim 48 wherein said binder comprises an acrylic binder.

50. The ink composition of claim 49 wherein said acrylic binder further comprises a unimodal random polymer.

51. A humectant set comprising at least two of the following:
(a) polyethylene glycol;
(b) an alkyl diol with adjacent —OH groups; and
(c) 2-pyrrolidone.

52. A method of printing an aqueous ink onto a recording medium comprising the steps of providing an ink composition comprising at least two of the following:
(a) polyethylene glycol,
(b) an alkyl diol with adjacent —OH groups, and
(c) 2-pyrrolidone; and
transferring said ink composition onto said recording medium.
